(19) United States
(12) Patent Application Publication
(10) Pub. No.: US 2012/0061110 A1
(43) Pub. Date: Mar. 15, 2012

(54) MULTICULTIVATOR FOR VERTICAL FARMING

(76) Inventor: Jose Leoncio Valdes Hernandez, Aguascalientes (MX)

(21) Appl. No.: 13/319,427

(22) PCT Filed: May 8, 2009
(86) PCT No.: PCT/MX2009/000041

§ 371 Date: Nov. 23, 2011

(51) Int. Cl. A01B 3/38; A01B 79/00

(52) U.S. Cl. 172/1; 172/694

(57) ABSTRACT

It provides a device called Multicultivator for vertical cultivation which base is made of structural steel an comprising at least three rudders for field work, an important feature is that the device can change the separation between the rudder from been virtually together. The Multicultivator has the ability to perform tasks simultaneously as subsoiling an fallow.

### INVENTION FIELD AND BACKGROUND

This invention relates to a device for performing vertical farming, which is built with steel structural elements. It relates to an apparatus for tillage, fallow vertical subsoiling and cultivation.

Similar growers examples can be found in the following documents: AU96867 S, AU158528 S, U.S. Pat. No. 4,548,276, MX 9504022; U.S. Pat. No. 6,494,270; ES 160321; MX4947 as patents, industrial models or designs. These documents are considered as the state of the closest prior art, but nevertheless, none of them has the configuration/or functionality of the object of this application, not even the shape and function that this device displays for this application can be suggested to have being developed from those similar growers, specifically, none of them is built with a frame which has a configuration that allows to obtain the land disturbed wrought to 80%, reduce power consumption (approximately 50 to 60%), and consequently fuel saving compared with the conventional tillage, getting an increase in the work performed, approximately 100% over current known systems.

### BRIEF INVENTION DESCRIPTION

This invention relates to a frame for farming (cultivation), which comprises a variable number of chisels arranged in two parallel metal bars. The chisels are placed equidistantly according to the bar in which it is located. The frame has the feature to put up with the mechanical forces that are originated in the farm without distortion, and low weight, also withstands the high loads resulting from the rupture of the fuse when a chisel is a snag.

The frame construction is such that allows that tractor can pull it a relatively high speeds without suffering deformation and carrying out the function that have been foreseen for this Multicultivator, which will be described later without being they limited.

### IMAGES BRIEF DESCRIPTION

Image 1 is an isometric view, top right side of the device of this invention.

Image 2 is a side view of the device of Image 1.

Image 3 is a top plan view.

Image 4 is a front elevation view

Image 5 is an isometric exploded view, top right

Image 6 is an isometric view in top right of a manner of this new device.

Image 7 is a right side view.

Image 8 is a top plan view.

Image 9 is a front elevation view.

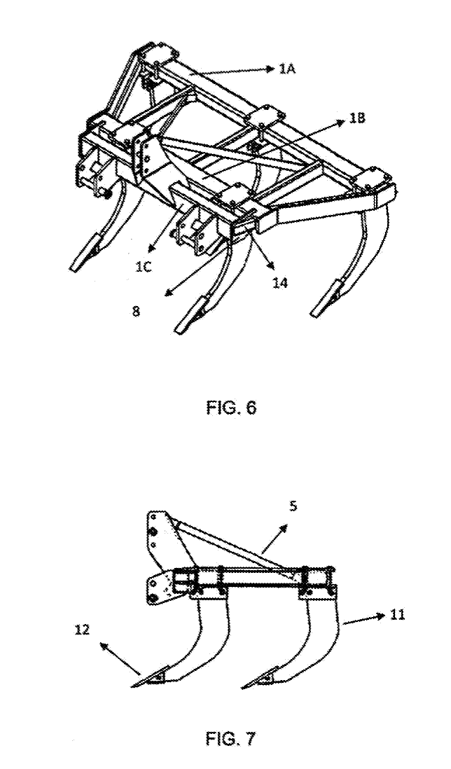

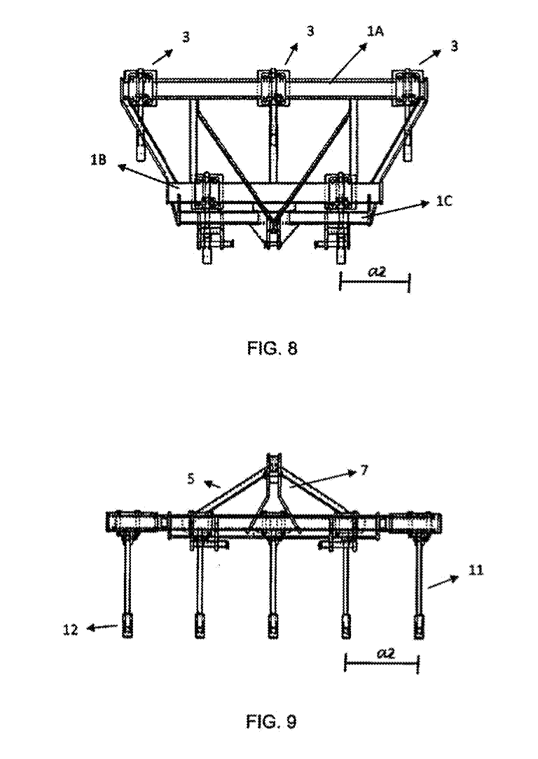

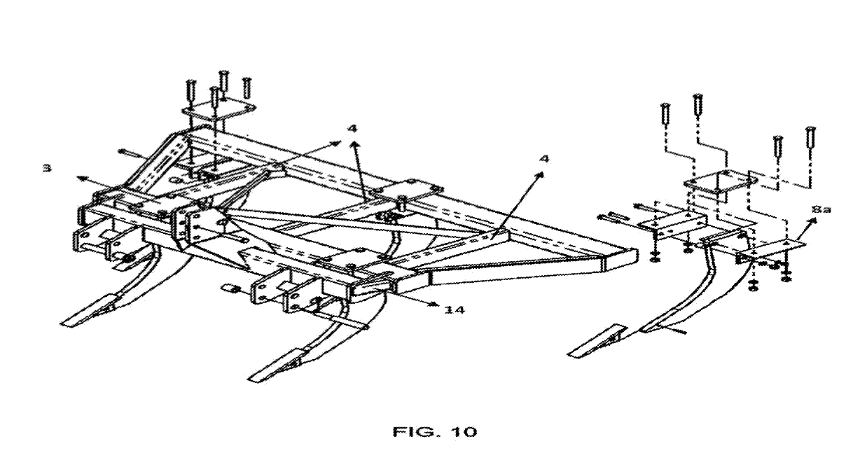

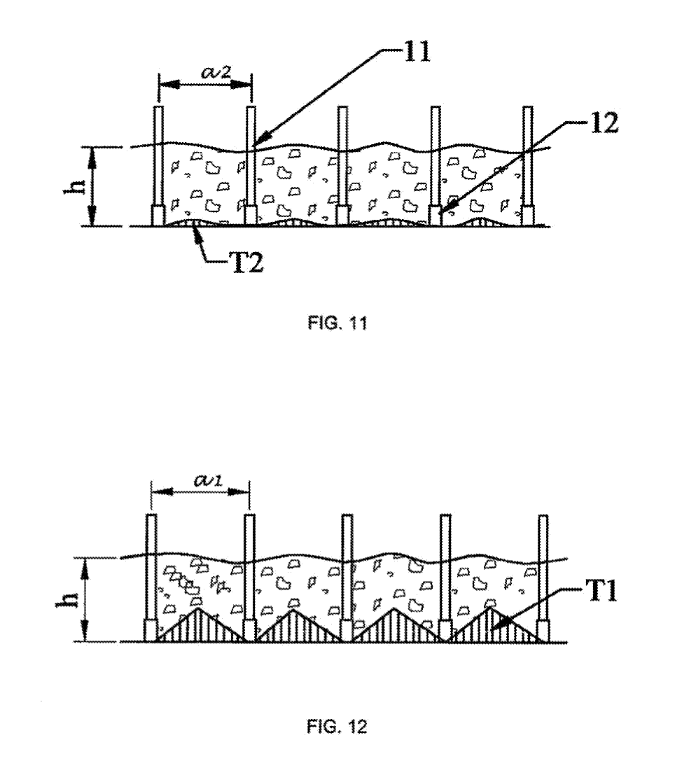

Image 10 is an isometric exploded view of the mode upper right of FIG. 6.

Image 11 shows the scheme of work underground in accordance with the present invention.

Image 12 shows the pattern of trade underground work.

### INVENTION DETAILED DESCRIPTION

As used herein, the Multicultivator is a mechanical device to work the land in order to cultivate, manufactured from structural steel or other material with adequate mechanical properties to withstand the mechanical stresses developed in this activity. The condition is that the chisels to remove the soil can be placed at a distance (a2) between centers 0 to 40 cm, preferably 20 to 35 cm, but preferably from 25 to 30 cm and still more preferably 30 cm, configuration shown in the accompanying images.

It has been called Multicultivator because this equipment has the ability to perform various tasks such as subsoiling, fallowing vertical farming operations. It is understood in this, that the terms chisel and rudder are equivalent.

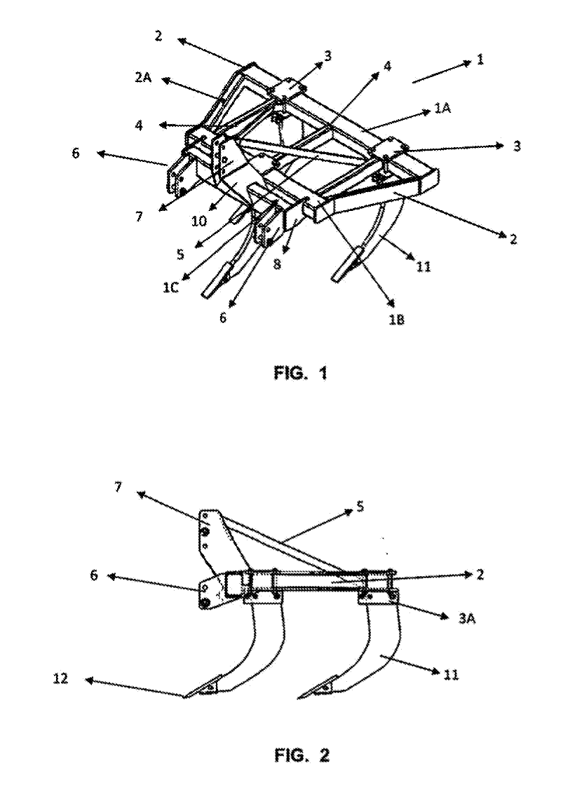

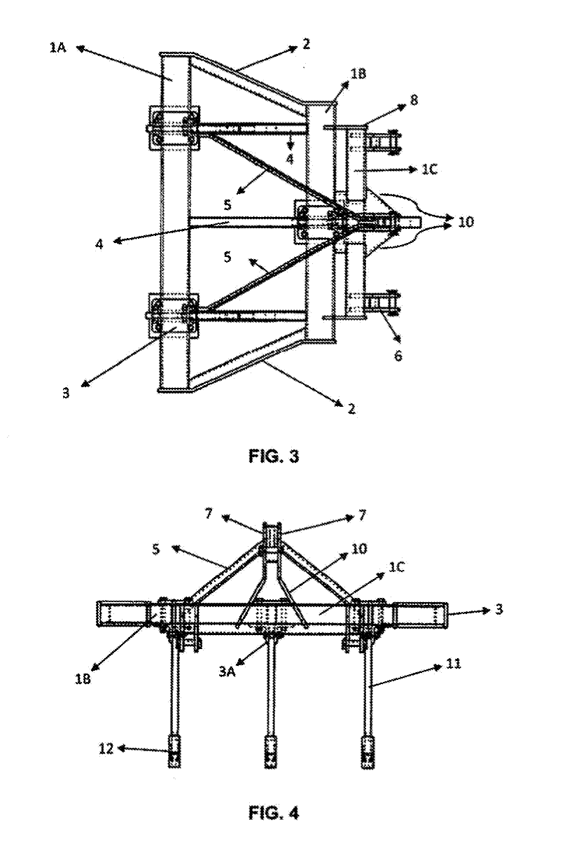

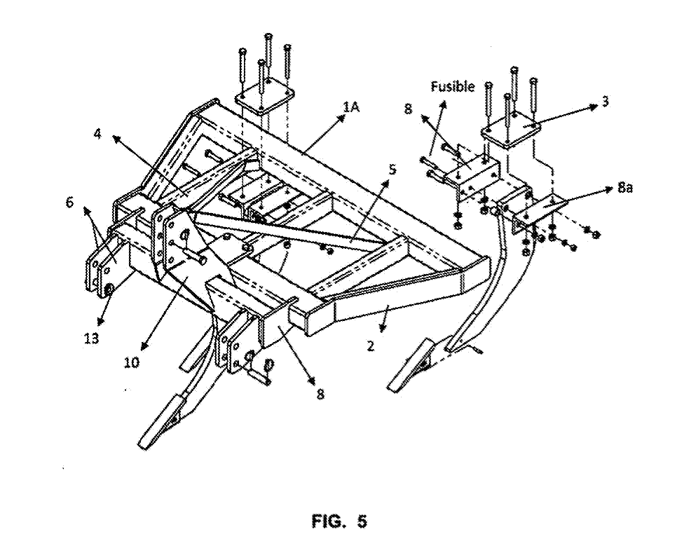

According to the figures, exemplary Multicultivator 1 comprises a body, composed of three main elements 1A, 1B and 1C (see FIGS. 1, 3 and 4), which are made from commercial or manufactured items. These bodies, which are rectangular in cross section, are located in parallel to each other, being the longest 1A and 1B following him and being of shorter length 1C. Items 1A and 1B are joined together on the inside of three tubular members 4, rectangular in cross section at the ends are joined by the reinforcement plate 2 with 2A. It should be noted that the number of elements as the tubular element 4 varies depending on the length of the elements 1A and 1B and design needs. Here a number is used to clearly describe the invention.

1C element comprises a tubular element made of a rectangular tubular profile commercially available or manufactured in accordance with design requirements. The element 1C is attached to the item 1B through plate 8. This item 1C is a rectangular cross section.

To 1C element is attached the tractor hitch, wherein said engaging element is formed with a pair of plates, 7 connected to another pair of plates, 10 (plates 7 and 10 can be a single bent plate or built separately) and a conventional locking pin.

In order to give stability and mechanical strength to the frame, two straps are placed 5. One end of these straps starts at the junction of the elements 7 elements 1A and 4, the second strap is positioned opposite to the first, see image 1. For straps means any commercially available or manufactured item that meets the condition of preventing the rotation of the element 1A.

On the front of 1C plates 6 and 13 join with the corresponding agricultural fasteners in order to attach to the lower arms for the system of three-point hitch of a tractor (not shown). This coupling system is already known and commonly used.

The joints among the different elements are made by appropriate welding or by suitable fasteners such as screws or suitable bolts (or rivets) as required.

It is important to point out that the plate 2 can be built by bending a cross beam and weld joint, or by the union of two smaller ones with welded joint, the plate 2 is attached to the elements 1A and 1B. 2A the internal reinforcement helps support the mechanical load that is generated during traction by the tractor (not shown) and also can be constructed from one or more pieces. This reinforcement 2A is a structural element which has different shapes. A structural element may include channels, angles, square tubular or rectangular plates together or any combination of these.

In order to hold the chisels, armed elements are placed, represented in general as the number 3, consisting of at least a top plate 3 and two angle sections 8A and associated fasteners. These elements 3 can slide along the longitudinal axis of 1A and 1B in order to give the separation between the 11 and their corresponding chisel tip 12. Even though the images shown the 3 elements have the constitution shown in different images, will be apparent to a person of ordinary skill in the art that can be used other means of securing the rudders, fixed or mobile, the condition is that they have the sufficient mechanical strength to withstand the mechanical work and can install a safety device like the fuse shown in image 5.

In one embodiment of the invention, on the element 1A are placed two of these chisels 11 and one at 1B. In another preferred embodiment of the invention, element A1 comprises three chisels while 1B comprises two, without this constituting a limitation, being obvious to a person skilled in the matter that can be placed different numbers of chisels, as required by means to farm, for example 5 in 1A and 4 in 1B. In general the number of rudders on each item 1A or 1B is calculated as follows:

T1A=T1B+1

In which T1A is the number of rudders on the item 1A and T1B is the number of rudders on the item 1B, being with T1A at least 2 and with T1B at least 1. While the amount of rudder is limited by the length of the elements 1A and 1B and the power of the tractor, mainly. For example, devices have been developed with 15 rudders in total, 7 in 1A and 6 in 1B.

In one embodiment of the invention is not limited to, which includes five chisels, the frame is reinforced with the structural element 14 which is a reinforcing plate placed between 1C and 8. A structural element may include channels, angles, square tubular or rectangular plates together or any combination of them.

The reinforcement required is determined by the requirements imposed by the mechanical design to prevent damage to the functioning of the structure.

With regard to armed elements 3, Parts 7, 10 and 6, are common in such equipments.

There are two important things to consider in the location of the rudders: first, the distance between them in the same structural element (1A or 1B) and secondly, the distance between the rudders considering different structural elements. In the first case the distance between rudders varies from 25-60 cm, while for the second case the rudders can be virtually placed at distances of 0 cm, in other words, between the rudders of the rudder element 1B and 1A element separation is almost null (see Images 8, 11 and 12 for example). In equipments of similar prior art to the present, this cannot be achieved by designing features of the structure. The position of the rudders that in these models is discrete, because there is a series of buffers in the elements, and the arrangement of the rudders (as V) cannot come among them (for example distance less than 35 cm) because the material jams formed by the disturbed soil and plant residues that are on the surface, which facilitates the binding material between the rudders and requires to stop the work required to eliminate binding, leaves the uneven terrain and avoids finishing the job.

In order to compare the efficiency on field, a series of operational tests were conducted and surprisingly significant difference was found in the amount of soil disturbed by the decrease in distance of only 5 cm between chisels.

Image 12 shows schematically a plot worked with a team from the state of the art, vertical tillage equipment of this type, due to their construction and design, helms cannot approach within 35 cm apart (in some cases the distance is greater) (a1, Image 12). The land has certain areas worked T1 that fail disturbing. In Image 12, h represents the depth of the crop and the distance between a1 rudders to the devices of the state of the art. To T1 is also known as raw land or land undisturbed. In the state of the art, the disturbed percentage is between 60 and 70%, for subsoils in a “V” with chisels placed 35 cm separation between them (minimum distance used in the state of the art), which not all of the commercially known subsoil give this away, so that when the distance is greater than the percentage of land disturbed is less. In the Multicultivator case of the present invention, the percentage of disturbed soil reaches 80% (see Image 11), using rudders to a preferred distance a2 of 30 cm.

Subfloors conventional rudders are available in “V” or delta with fixed positions, which prevents working the rudders at short distances (30 cm or less) and get stuck easily.

An important feature of the present invention is that the structure described above allows us to place the rudders almost in continuous positions, for example next to each other, unlike those known in the milieu in which the minimum distance is achieved, as noted earlier, is of 35 cm.

During test operation was surprisingly found, in the case of the present invention, that when the rudders are placed at a distance of 30 cm, a2 in Image 11, the efficiency of disturbed soil cross section is 80%, which is an increase of 10% for a 5-cm movement of the rudders on center which is a truly amazing value, the remaining 20% land is known as “raw” T2, and is a very low percentage considering the overall efficiency soil removed. In Image 11, a2 is less than or equal to 30 cm; preferably 30 cm, h is the depth of the crop. It is important to note that for comparative purposes, h is the same depth as that used in the case of the traditional crop.

The advantages of the present invention compared with another farm equipment known to the inventors are listed below:
a). It does not use fins at the top of the rudders and still achieve 80% efficiency of cross-section of soil removed. The use of such fins naturally requires more power consumption, contrary to that seen in this invention.
b). Leaves no plow pan.
c). It has low power consumption, compared to commercially known equipment, allowing us to use it as a equipment to multiple cropping (for example: several consecutive jobs in a single pass),in other words that can be used in combination with other elements, such as cutting discs, harrows, clod and eventually seeding and fertilizing, all in one pass, which is reflected in significant savings of time and energy.
d). Decreases fuel consumption, compared with the commercial equipments known for the same amount of land worked.
e). The ground worked with this invention has greater moisture retention.
f). Greater chance of the crops as it grows much faster per hectare, which means that as this operation is completed faster, you have enough time to perform another operations, for example those engaged in contract manufacturing, can contract manufacturing in largest number of acres in a menial job period.
g). Allow at least two tasks simultaneously: subsoiling and vertical fallow. Subsoiling operation is performed because it disturbs the soil and break the hardened layer that is formed by the continuous passage of machinery on the ground, and the vertical fallow because the efficiency of disturbed soil cross section is 80%, without inverting the soil layers. These two operations are performed by the fact of using the device of this invention with the separation between rudders and the distribution of these.
h). Allows to incorporate in the device object of the present invention a clod or a fertilizer, and cutting discs when there are many plant residues on the soil surface.
i). The present invention is classified as a vertical tillage equipment and therefore as an equipment of conservation tillage, which has many advantages in relationship to energy saving and conservation of soil and water.
   As a result of previous work, it is concluded that:
   Distances between rudders have a directly proportional effect on the cross section of tillage (disturbed cross-sectional area) and the average size of aggregates.
   The size of the aggregates is not affected by the operating speed of 4 to 6 km/h.
   The volume of tillage with a distance of 30 cm rudders compared to the vertical plow doing the work and then use the subsoil plow with disks and perform the work of fallow, is increased by 400% with an increase of only 25% in fuel consumption.

In accordance with the above described, the present invention also relates to a method for growing vertical which can be performed by the apparatus called Multicultivator 1, or some other device that can perform vertical farming and put their rudders at a distance 0 to 40 cm 30 cm preferably in a2. The method comprises:
a) Work the land by placing the device rudders tillage at a distance of 20 to 30 cm between enters, preferably 30 cm;
b) Start the tilling of the earth at a speed of 4 to 6 km/hr depending among other things the power of the tractor, the amount of rudders and hardness of the ground.

Having sufficiently described the invention, I claim as my property the contained in the following claims:

1. A mechanical device to till the with tillage chisels comprising a body attached to structural steel which comprises three main elements (1A, 1B and 1C), fabricated structural steel trade being rectangular in cross section, and placed parallel to each other, being (1A) the longest, (1B) the following in length and (1C)the least length.

2. The device according to claim 1, wherein the elements (1A) and (1B) are joined together, on the inside of them, through tubular members (4), of rectangular cross section and at the ends are joined by means of plates (2) with reinforcement (2A).

3. The device according to claim 2, wherein the component (1C) comprises a tubular element made of a rectangular tubular profile, the item (1C) is attached to the item (1B) by means of plates (8), the element (1C) binds to the tractor hitch element, the element coupling is formed with a pair of plates (7 and 10) or a plate with a double and conventional locking pin.

4. The device according to claim 3, wherein, attached to the frame, place two straps (5), one end of these straps starts at the junction of the elements (7) with the elements (1A and 4) the second strap is positioned opposite the first.

5. The device according to claim 4, wherein the front face (1C) bind plates (6) and related to agricultural fasteners (13) in order to attach the lower arms for the connection system in three points of a farm tractor.

6. The device according to claim 5, wherein the joints between the different elements are made by any permanent fastener or not, such as welding, screws, rivets or bolts etc., as required by the building material.

7. The device according to claim 6 wherein the plate (2) can be constructed by bending a slab or by the union of two smaller with welded joint, the plate (2) is attached to the elements (1A and 1B), the reinforcement (2A) helps to support the mechanical load that is generated during the drive from the tractor and also can be constructed from one or more pieces of commercial structural.

8. The device according to claim 7, wherein comprises it also armed elements consisting of at least an upper plate (3) and two angular profiles (8A) and their corresponding fasteners including to secure the rudders (11), these elements (3) can slide along the longitudinal axis of (1A) and (1B) to give the separation between the rudders (11) and their corresponding points (12)

9. The device according to claim 8, wherein the element (1A) is placed a variable number of rudders (11) and (1B) is placed a variable number of rudders (11).

10. The device according to claim 9, wherein the variable number depends on the following formula:
T1A=T1B+1
in which T1A rudders is the number of the item (1A) and T1B is the number of rudders on the item (1B).

11. The device according to claim 9, wherein in T1A is a minimum of 2 and T1B is a minimum of 1

12. The device according to claim 11, wherein the frame is reinforced with the structural element (14) placed between (1C) and (8).

13. The device according to claims 10 and 11, wherein the rudders can be placed at a distance (a2) 0 cm minimum and maximum of 30 cm.

14. The device according to claim 13, wherein the rudders are placed at a distance (a2) 25 to 30 cm, preferably 30.

15. A method for growing vertical using mechanical tillage in accordance with claim 1, further comprising:
a) Work the land by placing the device rudders tillage at a distance (a2) from 0 to 30 cm between centers;
b) Start the tillage of the soil to a speed of 4 to 6 km/h where fallow and subsoiling tillage involves simultaneous.

16. The cultivation method according to claim 15, wherein the distance (a2) between rudder is 30.

17. The method according to claim 16, wherein to get to 80% disturbed area.

18. The method according to claim 17, wherein a yield of at least 400% higher with respect to common operations plow to fallow followed vertical discs.
